(19) United States
(12) Patent Application Publication
(10) Pub. No.: US 2004/0264666 A1
(43) Pub. Date: Dec. 30, 2004

(54) Phone number filter user interface

(75) Inventors: Chunseng Guo, Surrey (CA); Charles Mathieson, Burnaby (CA)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/607,107

(22) Filed: Jun. 25, 2003

(51) Int. Cl. H04M 3/42

(52) U.S. Cl. 379/201.12; 379/210.02

(57) ABSTRACT

A user of a telephone system specifies a set of profiles specifying calls that will be handled in a certain fashion, the calls may by specified in a number of ways, such as a) country or area code of origin, particular originating numbers, originating numbers without ID (telemarketers), computer-generated calls, and the like; or b) the calls may be specified according to the status of the recipient, such as in a meeting, traveling, asleep, and the like; or c) calls that provide an override code to override an automatic rejection or an automatic shift to voice mail and ring through.

### TECHNICAL FIELD

The field of the invention is the operation of mobile telephone systems to filter incoming calls.

### BACKGROUND OF THE INVENTION

Today, mobile phones and their networks support the ability to forward unanswered and uncompleted calls to the network's voice mail system.

It is not, however, possible at present to filter incoming calls with any degree of sophistication. The voice mail answers anyone who calls, requiring in many systems that the user pay a fee for unwanted calls. Such fees can be quite annoying and can aggregate to a substantial amount of money, especially when the user is roaming or is in a foreign country.

In addition, the only way to avoid interruptions in a conference hall, important meeting, etc. is to shut off the mobile phone. Even if the user turns off the ringer on the phone, the vibrating mode will interrupt his thought process.

As telemarketers and other mass callers have become more aggressive and widespread, the fraction of unwanted calls increases.

Shutting off the phone, of course, introduces the possibility of missing an important call, thus negating one of the main benefits of a mobile phone.

It would be advantageous if the user were able to control the phone with more precision—allowing all calls, rejecting all but a selected group of callers, etc.

### SUMMARY OF THE INVENTION

The invention relates to a telephone system that permits the user to control access to the ringing and to the voice mail.

A feature of the invention is the ability to set up a standard default pattern of accepted and rejected calls

Another feature of the invention is the ability to change the pattern in response to a change in status, e.g. in a meeting or sleeping.

Another feature of the invention is the ability to change the pattern automatically, e.g. by time of day.

### BRIEF DESCRIPTION OF THE DRAWING

FIG. 1 illustrates schematically a system using the invention.

FIG. 2 illustrates factors involved in automatically selecting the current status.

FIG. 3 lists various actions to be taken when a filter criterion is satisfied (responses).

FIG. 4 lists various filters.

FIG. 5 shows steps in selecting and setting up a profile.

### BEST MODE OF CARRYING OUT THE INVENTION

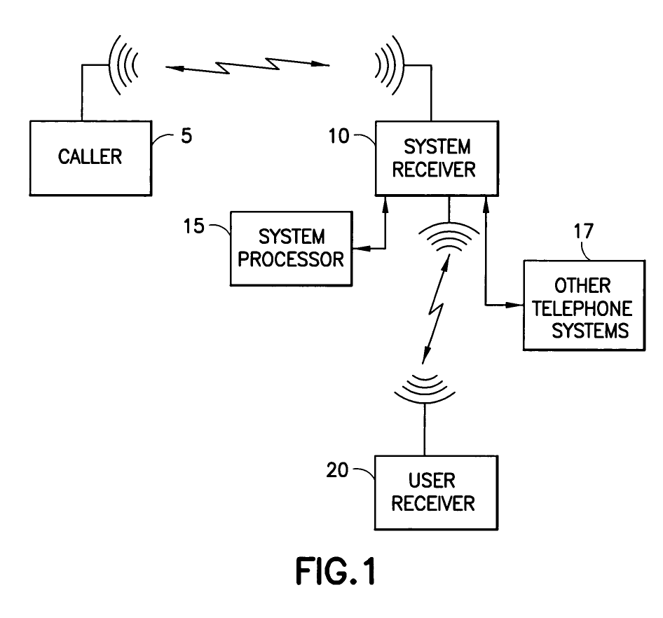

FIG. 1 illustrates, in simplified form, a mobile telephone system in which a caller 5 dials the number of a Customer's mobile handset 20. The telephone system receives that call in a system receiver 10, illustratively a base station receiving a call from a mobile phone.

In the standard pattern, the call rings on the Customer's mobile handset 20. If the handset is out of range of the mobile system, or the handset is turned off, System Processor 15 responds to Caller with a message, typically inviting Caller to leave a message on Customer's voice mail.

Some telephone systems offer additional services such as refusing calls from listed numbers, call waiting, etc. but these additional services are ordinarily not available to mobile phone users.

According to the invention, the functions available to Customer are increased by permitting the Customer to set up a set of profiles, which are a set of criteria that are applied to incoming calls and the action to be taken. Each set of criteria is called a filter and the action taken when the set of criteria is satisfied is called the response.

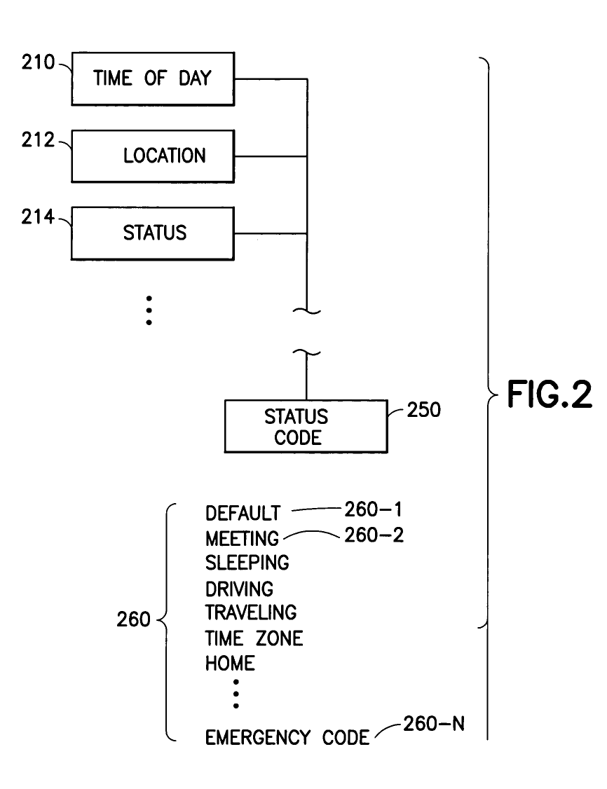

Bracket 260 in FIG. 2 indicates a sample list of filters 260-1 to 260-N with names indicating when they are intended to be used:

Default—the standard criterion for permitting calls to ring when no special status is specified

Meeting—when the Customer is in a meeting that should not be casually interrupted

Sleeping—when the Customer does not want to be awakened unless there is a specified occurrence (an emergency or a call from someone important)

Driving—when the Customer is driving with his mobile phone on, but does not want to receive calls of lesser importance

Traveling—when the Customer is in transit—on a plane, at the terminal and is probably temporarily out of range

Time Zone—when the Customer is in another time zone (e.g. Europe or Asia) and wants to adjust his working hours

Home—when the Customer wants ordinary business calls to be directed to voice mail, but wants to receive social, non-business calls

Emergency Code—when the Customer wants to give callers who know a special code the ability to override the automatic rejection of their call

Those skilled in the art will readily be able to devise additional situations where a filter would be appropriate. An advantageous feature of the invention is the ability of the Customer to set criteria and/or to devise new filters.

The Customer will set the criteria according to his needs. For example, Customer would ordinarily reject calls from telemarketers by rejecting incoming calls that do not have caller ID data associated with them. If Customer gets a significant number of business calls from another country or location that does not pass on caller ID data to his phone company, he may need to put up with telemarketers in order to receive the wanted calls.

Those skilled in the art will also appreciate that the filters listed above are not mutually exclusive and may advantageously be combined—e.g. the Customer may set the status to Meeting when in a different time zone and may set the Emergency Code option in connection with any of the other filters. For example, Filter 4-4 permits the caller to override a rejection (from another filter) while Filter 4-8 permits a caller (Boss) to ring through without having to override the rejection.

A profile may have different filters associated with it, depending on the time of day and status. For example, the filter for traveling in Europe will have different and more stringent criteria for accepting a call when sleeping than during local business hours, e.g. sending to voice mail all calls not on a list of business and family numbers. Thus, the same caller may be passed through at one time and sent to voice mail at another time.

Referring again to FIG. 2, the upper part of the Figure shows a number of boxes—Time of Day (210), Location (212) and Status (214) connected to a box 250 labeled Status Code. This portion of the Figure represents a portion of logic in system for changing filters (which may be automated). For example, box 210 would change the code to Sleeping at a preset time and the response associated with sleeping status would be applied; e.g. a message would inform the caller that Customer is traveling in Europe (where it is night) and request a voice message.

Box 212 represents an optional feature in which the system processor in the local phone company reacts to the handset making contact by storing the information that the Customer is in range (as usual) and also setting a flag in the processing system to change the location and associated profiles. As an example, the local phone company would pass a message back to the processor in the home phone company to change the status code to reflect the appropriate location.

Box 214 represents another optional feature in which status flags, e.g. sleeping, travel, etc. may be set, with the system automatically (e.g. at a preset time) changing the filter and response appropriately.

This feature also permits Customer to turn on or off preset responses in manual mode without re-keying all the details; e.g. setting status to travel with indefinite duration, then resuming Time Zone or Default status when ready.

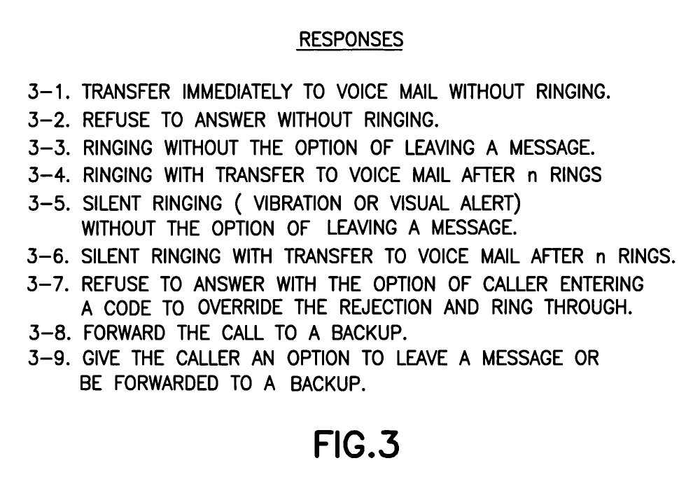

FIG. 3 shows a list of sample responses that may be used:

1. Transfer immediately to voice mail without ringing.

2. Refuse to answer without ringing.

3. Ringing without the option of leaving a message.

4. Ringing with transfer to voice mail after n rings.

5. Silent ringing (vibration or visual alert) without the option of leaving a message.

6. Silent ringing with transfer to voice mail after n rings.

7. Refuse to answer with the option of caller entering a code to override the rejection and ring through.

8. Forward the call to a backup.

9. Give the caller an option to leave a message or be forwarded to a backup.

10. Ring through for callers an a list.

11. Alert User and present a set of choices such as ring, transfer, voice mail.

12. Transfer to voice mail callers on a list.

Alternative 1) is suitable for situations in which Customer is unable (in a plane or driving in a state where phoning while driving is illegal) or highly reluctant to answer. Alternative 2) is suitable if the call can be identified as a telemarketer. Alternatives 8) and 9) are suitable when Customer gets a large number of business calls that can be handled by a backup.

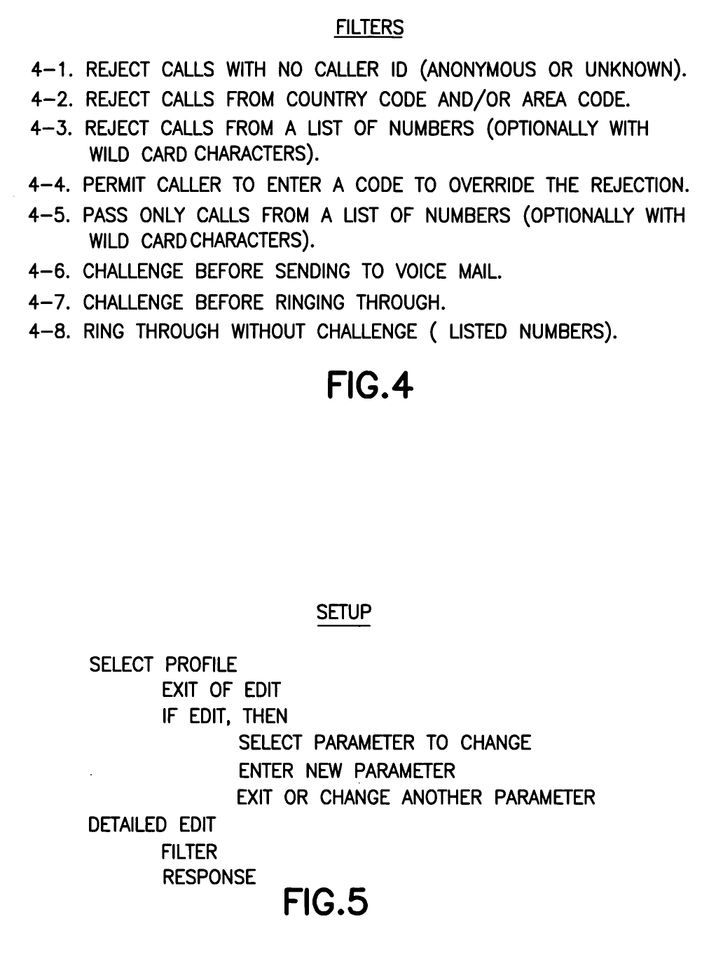

FIG. 4 shows a list of criteria that may be used in a filter:

1. Reject calls with no caller ID (anonymous or unknown).

2. Reject calls from country code and/or area code.

3. Reject calls from a list of numbers (optionally with wild card characters).

4. Permit caller to enter a code to override the rejection.

5. Pass only calls from a list of numbers (optionally with wild card characters).

6. Challenge before sending to voice mail.

7. Challenge before ringing through.

8. Ring through without challenge (listed numbers).

Setting up the Default profile and the other profiles would preferably be done from the mobile handset, though the phone company might permit its customers to use an Internet site to access their profiles. Optionally, the Customer could be permitted to modify the profile from any telephone, after entering a security code.

With the limited interface resources of a handset, consideration should be given to the sequence of operations to minimize the time and effort required of the Customer to manage the profiles.

FIG. 5 illustrates a possible sequence of operations:

The first screen would present a list of profiles that have been set up in advance—Default, Traveling, Time Zone, etc. The Customer could select a profile and use the preset parameters associated with it. After highlighting the profile name, the system would offer a choice of Edit the profile or Exit. For example, the Default profile might have: Sleeping from 11pm to 8am, Traveling from 8am to 9am, Business from 9am to 6pm, Traveling from 6pm to 7pm and Home from 7pm to 11pm.

A non-Default profile could be set by highlighting the profile name and entering relevant parameters. If the Customer wanted to modify a profile, the sequence would be to highlight the profile and press a key to enter Edit mode, where changes could be made (temporary or permanent). After each change, the Customer would have a choice of Exit or Continue Editing.

For example, a sequence for a business trip could be: Customer would highlight Travel, enter a start time and stop time; then highlight Time Zone and enter the start and stop times. For example, Customer is traveling to Europe, leaving the office Monday afternoon (start of Travel profile) and arriving at the branch office 9am GMT on Wednesday. The modified business travel schedule would start with the arrival in the office, with modification for business dinners and sleeping on the local time schedule.

For temporary changes, Customer could highlight the appropriate status and enter: start time and stop time (or indefinite).

For example, Customer is called to an important meeting that is not regularly scheduled. He highlights Meeting and enters start and stop times.

An optional feature of the invention is that, with appropriate software, the System Processor in the local phone company can automatically change the status of Customer.

Referring back to FIG. 1, System receiver 10, the closest base station to Customer's office, is in contact with other base stations of the same phone company and with other phone companies, in order to handle roaming calls that originate or terminate in the territory of the other telephone company.

When Customer is out of the office, his handset makes contact periodically with a local base station, so that the phone company can route incoming calls correctly. System processor 15, therefore, has access to Customer's location. It is within the skill of ordinary programmers, therefore, to modify the profile as though Customer had done it according to FIG. 2. For example, if Customer travels from his usual work location on the East coast to California, System Processor 15 would change the profile to Time Zone and switch to the profile set up for West coast time. Since the area of cells in a mobile network is relatively small, a telephone company could offer another option of recognizing when Customer is at the airport and changing the status to Traveling.

Although the invention has been described with respect to a limited number of embodiments, those skilled in the art will appreciate that other embodiments may be constructed within the spirit and scope of the following claims.

We claim:

1. A telephone system for connecting callers and users, comprising:
user-specifiable means for defining at least one filter for filtering incoming calls and taking user-definable responses on incoming calls that satisfy the requirements of said at least one filter, in which:
the user specifies a profile;
the user has the option of modifying parameters of the specified profile, including specifying at least one filter in the profile and specifying user-specifiable parameters thereof;
the system includes means for guiding the user through a setup sequence; and
the telephone system includes means for applying the user-specified profiles.

2. A telephone system for connecting callers and users according to claim 1, in which:
at least one profile depends on the status of the user, selected by the user from a list of at least two profiles, with a set of responses correlated with the status specified in the selected profile.

3. A telephone system for connecting callers and users according to claim 2, in which:
at least one profile includes at least two responses that depend on the time zone in which the user is located and the time of day in that time zone.

4. A telephone system for connecting callers and users according to claim 1, in which:
at least one profile has at least two responses that are activated according to the time of day.

5. A telephone system for connecting callers and users according to claim 4, in which:
at least two responses that are activated according to the time of day depend on the user's normal working hours and the user's normal sleeping hours.

6. A telephone system for connecting callers and users according to claim 1, in which:
at least one profile depends on the time zone in which the user is located.

7. A telephone system for connecting callers and users according to claim 6, in which:
the system identifies the time zone of the location of the user and automatically applies a profile if the time zone of the user corresponds to the time zone in the profile.

8. A telephone system for connecting callers and users according to claim 6, in which:
different profiles apply to Europe, Asia and the American continents.

9. A telephone system for connecting callers and users according to claim 1, in which:
at least two filters apply a different response to an incoming call of the same category.

10. A telephone system for connecting callers and users according to claim 1, in which:
the system identifies the location of the user.

11. A telephone system for connecting callers and users according to claim 1, in which:
calls that satisfy a specified criterion pass through the filter even if they do not satisfy another criterion of the filter.

12. A telephone system for connecting callers and users according to claim 1, in which:
the user specifies a set of at least one response to at least one filter.

13. An article of manufacture comprising a program storage medium readable by a computer, the medium embodying instructions executable by the computer for performing method steps in a telephone system for connecting callers and users, comprising:
defining at least one filter for filtering incoming calls and taking user-definable responses on incoming calls that satisfy the requirements of said at least one filter, in which:
the user specifies a profile;
the user has the option of modifying parameters of the specified profile, including specifying at least one filter in the profile and specifying user-specifiable parameters thereof;
the system includes means for guiding the user through a setup sequence; and
applying the user-specified profiles.

14. An article of manufacture according to claim 13, in which:
at least one profile depends on the status of the user, selected by the user from a list of at least two profiles, with a set of responses correlated with the status specified in the selected profile.

15. An article of manufacture according to claim 14, in which:
at least one profile includes at least two responses that depend on the time zone in which the user is located and the time of day in that time zone.

16. An article of manufacture according to claim 13, in which:
at least one profile has at least two responses that are activated according to the time of day.

17. An article of manufacture according to claim 16, in which:
at least two responses that are activated according to the time of day depend on the user's normal working hours and the user's normal sleeping hours.

18. An article of manufacture according to claim 13, in which:
at least one profile depends on the time zone in which the user is located.

19. An article of manufacture according to claim 18, in which:
the system identifies the time zone of the location of the user and automatically applies a profile if the time zone of the user corresponds to the time zone in the profile.

20. An article of manufacture according to claim 18, in which:
different profiles apply to Europe, Asia and the American continents.

21. An article of manufacture according to claim 13, in which:
at least two filters apply a different response to an incoming call of the same category.

22. An article of manufacture according to claim 13, in which:
the system identifies the location of the user.

23. An article of manufacture according to claim 13, in which:
calls that satisfy a specified criterion pass through the filter even if they do not satisfy another criterion of the filter.
